(19) United States
(12) Patent Application Publication
(10) Pub. No.: US 2009/0299646 A1
(43) Pub. Date: Dec. 3, 2009

(54) System and method for biological pathway perturbation analysis

(76) Inventors: Soheil Shams, Manhattan Beach, CA (US); Bruce Hoff, Renton, WA (US)

Correspondence Address: TOPE-MCKAY & ASSOCIATES;CARY TOPE-MCKAY, 23852 Pacific Coast Highway #311, Malibu, CA, 90265, US

(21) Appl. No.: 12/459,702

(22) Filed: Jul. 7, 2009

Related U.S. Application Data
(63) Continuation of application No. 11/193,408, filed on Aug. 1, 2005.
(60) Provisional application No. 60/592,246, filed on Jul. 30, 2004.

(51) Int. Cl. G06F 19/00

(52) U.S. Cl. 702/19

(57) ABSTRACT

The invention provides system and methods for analyzing the perturbation of one or more biological pathways. In one embodiment, expression values for each of a plurality of genes for one or more experimental conditions may be received. Gene differential regulation values may then be calculated for each of the plurality of genes across each of the one or more experimental conditions. The gene differential regulation values may then be grouped by the biological pathway and experimental condition from which each gene differential regulation value originated yielding one or more pathway-condition data sets. Pathway perturbation values may then for each of the one or more pathway-condition data sets using the gene differential regulation values. These pathway perturbation values may be clustered, used to identify biological pathways or experimental conditions for further analysis, and/or utilized to build a classifier for classifying additional experimental data.

### PRIORITY CLAIM

This application is a Continuation Application of U.S. patent application Ser. No. 11/193,408, filed on Aug. 1, 2005, entitled, “System and Method for Biological Pathway Perturbation Analysis,” which is a non-provisional application which claims the benefit of U.S. Provisional Patent Application No. 60/592,246, filed Jul. 30, 2004, which is hereby incorporated herein by reference in its entirety.

### FIELD OF THE INVENTION

This invention relates to systems and methods for identifying, grouping, analyzing, classifying and displaying the perturbation of biological pathways via differential regulation of genes within those pathways.

### BACKGROUND

Gene microarrays are powerful tools for determining which, among a large number of genes in a given genome, have activity levels perturbed by an experimental condition of interest (e.g., disease, applied drug, organismal state, or other condition). However, the large amount of data produced from gene microarrays can be of limited use if this data is not viewed from the appropriate perspective or using the appropriate tools.

The appropriate perspective from which to view a large amount of data may depend on the experimental and/or institutional goals of those investigating the data. For example, academic or pharmaceutical researchers may be especially interested in the knowledge that is discernable from a large amount of human microarray data as it relates to the interaction of human genes and their expressed proteins within and among cells. This knowledge may ultimately be useful in drug target identification, drug development, and/or for other purposes.

Current analytical techniques often fail to manipulate and/or mine gene microarray data sufficiently to reveal information contained therein that is relevant to the goals of particular researchers/institutions. These and other problems exist in the art.

### SUMMARY

The invention solving these and other problems in the art relates to a system and method for network analysis of genes, gene perturbation, biological pathways, and biological pathway perturbation. The invention also relates to a system and method for utilizing biological pathway information in a classification system.

Gene microarray data, on its surface, may provide simple expression values for select genes across select experimental conditions. To obtain a richer, more global view of this data, the system and methods of this invention may place perturbations of gene expression by different experimental conditions into the context of biological pathways. In some embodiments, a biological pathway may include any grouping of interrelated genes or their protein products, which influence each other's activity levels and which may collectively accomplish some metabolic function, or other biological function. The benefit of identifying such perturbed pathways may include: inter alia placing the gene perturbations into a context of biological understanding, identifying attractive targets for novel drugs, or other benefits.

One benefit of placing gene perturbations into a context of biological understanding, may be illustrated in the following example. In this example, an experiment may produce a list of 100 genes differentially regulated in an experimental condition of interest. A list of two or three biological pathways in which the perturbed genes are thought to reside may then be introduced to the experimental data. The introduction of the biological pathways may serve to make the perturbation data more meaningful to a researcher interpreting the experimental results. Furthermore, if the researcher were to analyze the pattern of pathway perturbation across a number of different experimental conditions, it may be possible to identify relationships among the biological pathways. For example, if a set of pathways are perturbed or not perturbed together across a set of experiments, the researcher may hypothesize a relationship between these pathways. Furthermore, if the relationship among pathways is identified in such a way that it creates a certain topological organization of pathways, then the gene or protein constituent of these pathways may be examined based on this topological organization. This altered perspective of examination may lead to the identification of potentially “informative” genes or proteins. Such genes or proteins might be critical components connecting pathways together or critical points in biological processes.

One benefit of pathway perturbation analysis for drug discovery may be illustrated in the following example. In this example, a microarray analysis of a disease state (e.g., an experimental condition) may reveal a primary gene that is unusually up or down-regulated when the disease is present. However, the primary gene itself may be a poor candidate for targeting with a drug, because it is down regulated instead of up-regulated, and suppression of genes by pharmaceutical agents may be easier than activation. In this example, it may be possible that other genes related to or connected in a pathway to the primary gene are known which make better targets such as, for example, a secondary gene which is a known suppressor of the primary gene. This secondary gene may then be targeted for suppression, thus, activating the primary gene. Alternatively, a tertiary gene that reacts to a previously identified pharmaceutical compound may be identified which affects the primary gene, obviating the need to find a novel active compound. Other benefits from the use of biological pathway information with gene expression data may exist.

According to one embodiment, the invention may include a process, wherein the perturbation of one or more biological pathways may be analyzed. Identifiers for a plurality of genes and their expression values for one or more experimental conditions may be received. Gene differential regulation values may then be calculated for each expression value of each of the plurality of genes under each of the one or more experimental conditions. Gene differential regulation values may be obtained using the experimental expression value for a gene vs. a control value for that gene.

In one embodiment, for each experimental condition, gene expression values, their gene differential regulation values, corresponding gene identifiers and/or other data may be grouped according to the biological pathways from which the genes are thought to originate. This grouping may yield a set of expression values, gene differential regulation values, gene identifiers and/or other data for each pathway/experimental condition instance. In one embodiment, some or all of this data may be referred to as a pathway-condition data set.

In one embodiment, a pathway perturbation value may then be calculated for each of the one or more biological pathways/experimental condition instances using the data in the corresponding pathway-condition data set. This calculation may be carried out by any one or more of numerous equations, algorithms, or other methods.

In one embodiment, a subset of the biological pathways may then be selected to obtain a list of potentially significant pathways for further study. In some embodiments, some or all of the pathways for a certain experimental condition may be selected. In other embodiments, some or all of the pathways may be selected for some or all of the experimental conditions. Multiple methods of performing this selection may be utilized such as, for example, sorting the biological pathways based on the pathway perturbation values for a selected experimental condition and selecting pathways whose perturbation level exceeds some threshold. An additional method for selecting a subset of biological pathways may include selecting the n most perturbed pathways for a certain experimental condition, where n is a number chosen by the user.

In one embodiment, one or more perturbation indicators for the selected pathways may then be displayed to a user or operator via a graphical user interface. These perturbation indicators may aid a user or investigator in visualizing the perturbation of a biological pathway. In one embodiment perturbation indicators may be constructed by superimposing the gene differential regulation value (or an indicator thereof) for each gene on top of a graphic representation of some or all of the genes in a pathway. Numerous methods may be used to indicate the perturbation of a pathway such as, for example, drawing a rectangular icon for each gene in a pathway, wherein the rectangle is color-coded to show the sign and magnitude of the gene's differential regulation value. In some embodiments, differential indicators other than color coding may be used, for example, grey-scale, differential shading, differential patterns, or other differential indicators. In one embodiment, the color-coded rectangles representing the genes in a biological pathway may be arranged sequentially, corresponding to their arrangement (e.g., their sequential roles in a signaling cascade) in the biological pathway.

Another example of a method of indicating the perturbation of a pathway may include drawing a circular icon for each gene in a pathway, wherein the circular icon is color-coded (or otherwise differentially indicated) to show the sign and magnitude of the gene's differential regulation value. Other perturbation indicators for genes and biological pathways may be used as well as other methods of displaying/visualizing the perturbation of genes and/or biological pathways.

As mentioned herein, the aforementioned perturbation indicators/display methods may be used for some or all of the biological pathways for a single experimental condition/control pair. However, these indicators/display methods may also be used for some or all of the biological pathways for a number of different experimental conditions (e.g. different diseases, different drugs, different time points, or other conditions) simultaneously. Additionally, these different experimental conditions may be utilized in unique ways to group and/or analyze the experimental results. For example, beyond or in addition to parallel analysis of individual experimental conditions, one may rank the perturbation levels of a pathway for a number of experimental conditions, then rank the experiments according to how greatly they perturb the pathway of interest. Additional examples of analysis may include: ranking the perturbation levels of all the experiment-pathway instances to pick those combinations which create the greatest pathway perturbation; applying unsupervised clustering to the biological pathways, across experiments, to show pairs or groups of pathways which are similarly perturbed across experimental conditions; applying unsupervised clustering to the experimental conditions, across pathways, to show pairs or groups of experiments which similarly perturb the pathways; or other methods. A further example of analysis may include, applying supervised clustering to the experimental conditions, given that an experimental condition may be a priori subdivided into two or more classes, across pathways, to create a classifier predicting the class of an unknown experimental condition based on its pathway perturbation pattern.

In one embodiment, the invention provides a computer-implemented system enabling performance of biological pathway perturbation analysis or other features, functions, or methods described herein. In another embodiment, the invention provides a computer readable medium for performing biological pathway perturbation analysis or enabling other features, functions, or methods described herein.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a process according to an embodiment of the invention for visualizing biological pathway perturbation.

FIG. 2 illustrates a matrix of gene expression values according to an embodiment of the invention.

FIG. 3 illustrates a matrix of pathway perturbation values according to an embodiment of the invention.

FIG. 4 illustrates a visualization of hierarchical clustering of biological pathway perturbation and experimental conditions according to an embodiment of the invention.

FIG. 5 illustrates a process according to an embodiment of the invention for building a classifier.

FIG. 6A illustrates a self-organizing map according to an embodiment of the invention.

FIG. 6B illustrates a self-organizing map according to an embodiment of the invention.

FIG. 7 illustrates a process for preparing a graph according to an embodiment of the invention.

FIG. 8A illustrates a graph according to an embodiment of the invention.

FIG. 8B illustrates a graph according to an embodiment of the invention.

FIG. 9 illustrates a system for analyzing biological pathway perturbation according to an embodiment of the invention.

### DETAILED DESCRIPTION

The invention relates to a system and methods which identify, calculate, and/or organize the perturbation of biological pathways and their constituent genes. The methods of the invention may take as input a list of genes with their corresponding expression values under a set of different experimental conditions. Along with the list of genes and their expression values are a set of biological pathways in which each of these genes is thought to belong. It should be noted that genes may, and often do, belong to multiple pathways. Some genes are not known to belong to any known biological pathways. Biological pathways are essentially groups of interrelated genes or their protein products, which influence each other's activity levels and which may accomplish some metabolic or other biological function.

Given the above data, the invention aims, inter alia, to calculate the significance of each pathway for each of one or more experimental conditions. A measurement, value, or level of this significance may then be used to cluster and/or rank various pathways in order of their significance (or degree of perturbation) in various experimental conditions and thus point researchers towards a better understanding of basis of diseases, mechanisms of action for drugs or drug candidates, or towards other information or discovery.

The invention further enables grouping or clustering of biological pathways and conditions based on the pattern of pathway perturbations. Once the degree of perturbation of a pathway for a given condition is identified, grouping or clustering enables identifying potentially interrelated pathways. Similarly, perturbation information may be used to group or cluster experimental conditions based not on the raw expression values of individual genes but by the pattern of their effects on a group of biological pathways. This information may be useful in understanding which experimental conditions may have similar biological bases. This information may also be a useful approach for constructing classifier systems where pathway perturbation values may be used to train a classifier to discriminate between different experimental conditions or for other operations.

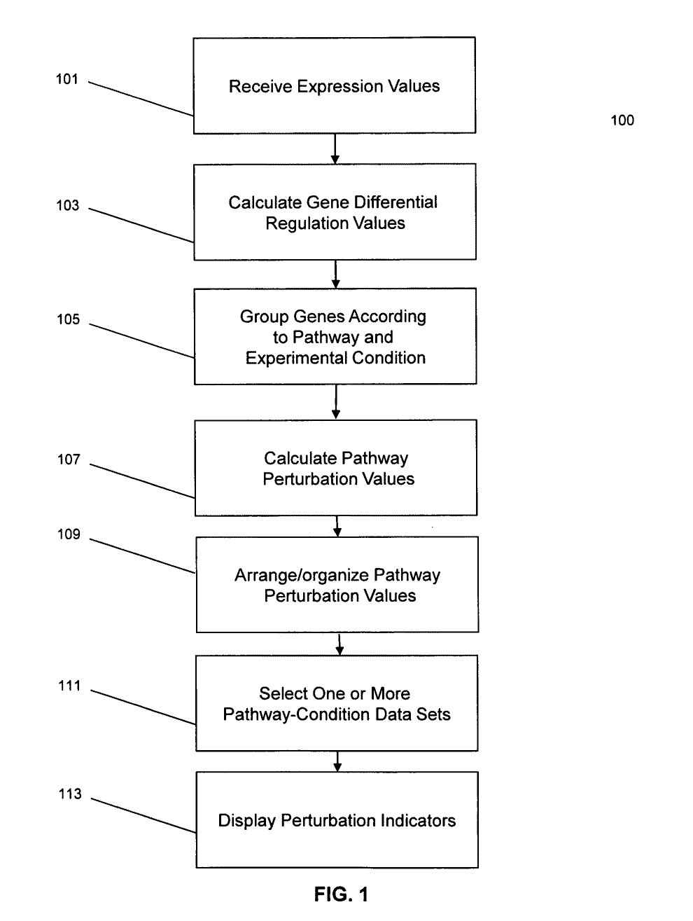

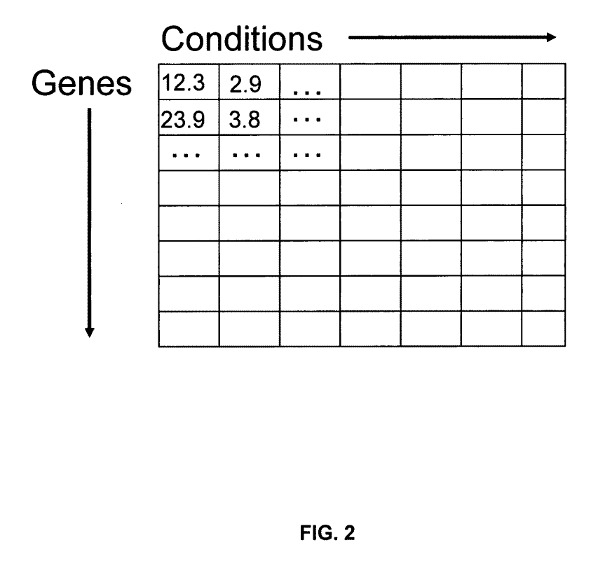

FIG. 1 illustrates process 100, wherein the perturbation of one or more biological pathways may be analyzed. In an operation 101, the identifiers for a plurality of genes and their expression values for one or more experimental conditions may be received. In one embodiment, a matrix of gene expression values for the set of one or more experimental conditions may be constructed. Such a matrix is illustrated in FIG. 2.

Referring back to FIG. 1, in an operation 103, gene differential regulation values may be calculated for each expression value of each of the plurality of genes under each of the one or more experimental conditions. Gene differential regulation values may be obtained using the experimental expression value for a gene vs. a control value for that gene. For example, for a single measurement of gene expression for an experimental condition, the expression level for a control may be subtracted from the measurement obtained for the experimental condition. This may leave a positive, negative, or zero value (depending on whether the experimental condition increased, decreased, or failed to affect the expression of the particular gene) that indicates the differential regulation of the particular gene.

In some embodiment, the control and each experimental condition expression value may be measured in replicate, for each gene. Measuring replicate values may increase the statistical significance of the resultant gene differential regulation values. An example of the calculation of a gene differential regulation value using replicates may include a single experimental condition, termed “diseased.” In this example, ten disease samples may have been obtained and the expression levels of 1000 genes may have been measured for the ten samples. For a control, there may be five “normal” samples available, and the expression levels for the same 1000 genes have been measured in the normal/control condition. Thus each of the 1000 genes to be measured for the “diseased” experimental condition will have ten replicate measurements, and each of the 1000 genes will have five control replicates.

In some embodiments, the measurement of gene expression values may include a certain amount of bias and/or noise that are not necessarily due to biological processes, but rather may be introduced as an artifact during the experimental process. As such, it may be important to not only make a measurement of gene differential regulation level, but also to provide a measure of confidence in the fact that the two measurements (e.g., expression under an experimental condition and expression under control conditions) used for a gene differential regulation value are truly different. A “p-value” may be used for this purpose. A p-value may comprise a false positive rate for each gene differential regulation value or the probability that the gene differential regulation observed for an experimental condition could have resulted without the experiment condition as influence For example, a p-value may be calculated in addition to the replicate measurements of the regulation of a gene in two conditions (e.g., experiment and control). This p-value indicates the probability that the two measurements are essentially the same (e.g., come from the same distribution). For example, a p-value of 0.05 may indicate that there is a 5% chance that the gene measured in two conditions (e.g., experiment vs. control) is not differentially regulated. There may be several ways to calculate a p-value. In some embodiments, the method used to calculate the gene differential regulation value may determine the manner in which the p-value is calculated. Table 1 illustrates different manners of obtaining the p-value, based on the method used to calculate the gene differential regulation value.

TABLE 1

| Differential Regulation | P-Value |
|---|---|
| Expression value mean minus | p-value from t-test. |
| Control mean. | |
| T-Statistic. | p-value from t-test. |
| Expression value mean minus | p-value from Mann-Whitney test. |
| Control mean. | |
| Mann-Whitney statistic. | p-value from Mann-Whitney test. |

A t-test is a statistical test known to those skilled in the art, wherein the statistical significance of the difference between two means is assessed. A t-statistic is the ratio of the difference between two population means to the standard error within the populations. Therefore, in some embodiments, if the gene differential regulation value is obtained using the difference between the expression mean (the mean of all replicates measured for a single gene for a single experimental condition) and the control mean (the mean of all control replicates for the gene), or using the t-statistic, the p-value may be calculated using a t-test. In other embodiments, if the gene differential regulation value is calculated using expression mean minus control mean or using a Mann-Whitney statistic, the p-value may be calculated using a Mann-Whitney test. A Mann-Whitney statistic (a.k.a. a Wilcoxon statistic) is a statistic that replaces numeric point input values with their ranks (their positions in an ordered list of their values). Likewise, a Mann-Whitney test is the computation of the significance of the Mann-Whitney statistic. Both of said tests are well known to those skilled in the art and may be computed by numerous software tools. Other manners of determining a p-value may be used, as long as each experimental condition for each gene gets a single numerical value for differential regulation and an associated p-value. Note that the p-value may only be calculated if there are replicated conditions, as in the example given earlier. In one embodiment, if no replicates are available, then no p-value is calculated. Other methods for assessing the confidence in the differential regulation may be used to estimate the p-value. For example, genes having similar expression values may be grouped together and used as “fake-replicates” to build the statistics used in the calculation of a p-value. If no p-value is obtained, the methods of the invention may be accomplished without p-values, as would be apparent to one of skill in the art from the description provided herein.

In an operation 105, for each experimental condition, the gene expression values, their gene differential regulation values, any corresponding p-values, and/or corresponding gene identifiers may be grouped according to the biological pathways from which the genes originate. This grouping may yield a set of expression values, gene differential regulation values, p-values, and/or gene identifiers for each pathway/experimental condition instance. In one embodiment, some or all of this data may be referred to as a pathway-condition data set.

In some embodiments, biological pathways may overlap. In some embodiments, not every measured gene is associated with a pathway. For example, Pathway 1 may include gene 1, gene 5, gene 30 and others, while Pathway 2 may include gene 4, gene 5, gene 7 and others.

In an operation 107, a pathway perturbation value may be calculated for each of the one or more biological pathways/experimental condition instances using the data in the corresponding pathway-condition data set. This calculation may be carried out by any one or more of numerous equations, algorithms, or other methods. In some embodiments, not all of the genes or gene differential regulation values for the genes identified in a pathway may be used to calculate the pathway perturbation value. For example, in one embodiment, all genes in a pathway/experimental condition instance whose p-value is below a predetermined threshold (a low false positive rate) may be selected. One example of calculating a pathway perturbation value may include calculating the average of the absolute value of the gene differential regulation value of the selected genes. This may give a single number which increases as the significant perturbations of the genes in the pathway increase. In some embodiments, all of the genes or gene differential regulation values may be used to calculate the pathway perturbation value. For example, if no p-value was measured (because of lack of replicates or for other reason), then all of the genes in a particular biological pathway may be used to calculate the pathway perturbation value.

In one embodiment, a formal representation (e.g., the pathway perturbation value) of the perturbation of pathway p for experimental condition c, ρpc may be defined as:

$${ρ}_{pc} = {\sum }_{j ∈ {L}_{p}} \vert {d}_{jc} \vert / ‖ {L}_{p} ‖$$

In the above equation, d_{jc} is the differential regulation of gene j in condition c and Lₚ is the set of all genes in pathway p whose p-value of differential regulation is lower than a predetermined threshold. Again, if no p-value was measured, Lₚ would include all genes in pathway p.

In one embodiment, the p-value may also be used as a weighting parameter in calculation of a pathway perturbation value, as opposed to a simple filtering mechanism. In such a scheme, all genes may be used in the calculation of ρ_{pc} but each gene's p-value weighs the contribution of that gene to the overall measure. For example:

$${ρ}_{pc} = {\sum }_{j ∈ {L}_{p}} \vert {d}_{jc} \vert ( 1 - {η}_{jc} ) / {λ}_{p}$$

In the above equation, η_{jc} is the p-value associated with the differential regulation of gene j in condition c, having values in the range zero to one, and λp is defined as the total number of genes in pathway p. Furthermore, the normalization factor λp may be measured as the number of genes in pathway p regardless of the availability of measurements for all genes or their specific p-values.

In one embodiment, the pathway perturbation value, ρ_{pc}, can also be calculated simply as ||Lp||/λp. This method essentially measures the ratio of the number of differentially regulated genes (those that have been found to be different by having a p-value less than a predetermined threshold) to the total number of genes in the pathway (or at least those that have been measured).

Other similar measures can be used. For example, a function may be applied to all p-values for the genes in a given pathway: ρ_{pc=ƒ(η}_{jc}, λp) such as, for example:

$${ρ}_{pc} = {\sum }_{j ∈ {L}_{p}} ( 1 - {η}_{jc} ) / {λ}_{p}$$

In other embodiments, raw gene expression data may be used to compute a multivariate chi-squared statistic that may serve as the pathway perturbation value. This multivariate chi-squared statistic may be calculated using the experiment and control samples as the two populations to be compared, and the pathway genes as the dimensions of each sample. Specifically:

$$φ = [ n - 1 - 0.5 ( p + m ) ] log [ \frac{\vert T \vert}{\vert W \vert} ]$$

Where, m=the number of conditions, ignoring/combining replicate measurements, n=the number of conditions, counting replicate measurements separately, p=the number of genes in the biological pathway under consideration, and T=the total sum of squares and cross-products matrix. Let X be the p by n matrix of gene measurements. Let Y be a modification of X in which the mean of each row (gene) is subtracted from each entry. Then T=Y Y′. Let W=within-sample total sum of squares and cross-products matrix. Let Z be a modification of X in which the mean of each row (gene) within each experimental condition subtracted from each entry. Then W=Z Z′. If the number of genes, p, is greater than the smallest number of replicates for a condition, the dimensionality reduction techniques, familiar to those skilled in the art of multivariate statistics, may be used on the data (e.g., principal component analysis, multidimensional scaling, self-organizing map, or other methods) to lower the dimensionality of the data matrix X prior to computing the chi-squared statistic.

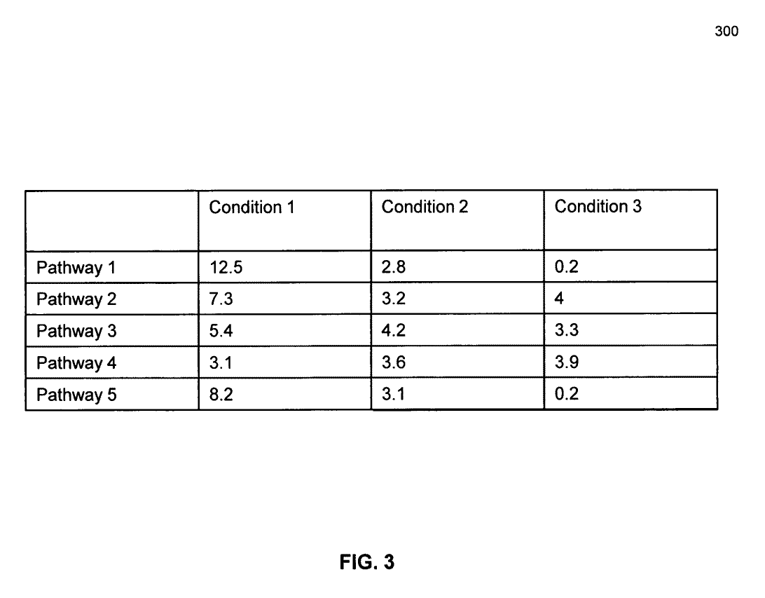

In an operation 109, the resultant pathway perturbation values may be arranged/organized so that the data reflected therefrom may be analyzed and/or operated upon. In one embodiment, the pathway perturbation values for each pathway-condition data set may be organized into a matrix that contains as elements biological pathways organized across one axis, and experimental conditions on another axis. FIG. 3 illustrates a perturbation matrix (e.g., a matrix of pathway perturbation values, ρ_{pc}) for each pathway under a number of experimental conditions which may be constructed according to an embodiment of the invention.

In an operation 111, a subset of the pathway-condition data sets may be selected to obtain a list of potentially significant pathways and/or experimental conditions for further study. In some embodiments, some or all of the pathway-condition data sets for some or all of the experimental condition may be selected. In other embodiments, some or all of the pathway condition data sets may be selected for some or all of the biological pathways. Multiple methods of performing this selection may be utilized such as, for example, sorting the biological pathways based on the perturbation levels for a selected experimental condition and selecting pathway-condition data sets whose pathway perturbation value exceeds some threshold. An additional method for selecting a subset of pathway-condition data sets may include selecting the n most perturbed pathways (according to the pathway perturbation value) for a certain experimental condition, where n is a number chosen by the user. In one embodiment, an some or all of the perturbation matrix may be displayed, showing the selected pathways for all or a portion of the experimental conditions.

In an operation 113, one or more perturbation indicators for the selected pathway-condition data sets may be constructed and displayed to a user or operator. In some embodiments, these indicators may aid a user or investigator in visualizing the perturbation of a biological pathway by superimposing the gene differential regulation value (or an indicator thereof) for each gene on top of a graphic representation of the genes in a pathway. Numerous methods may be used to indicate the differential regulation of a gene in a pathway such as, for example, drawing a rectangular (or other shape) icon for each gene in a pathway on a diagram depicting the pathway, wherein the rectangle is color-coded to show the sign and magnitude of the gene's differential regulation value. In some embodiments, the color-coded rectangles may be superimposed below, above, or on top of (surrounding) each gene's identifier. In some embodiments, differential indicators other than color coding may be used such as, for example, grey-scale, differential shading, differential patterns, or other differential indicators. In one embodiment, the color-coded rectangles representing the genes in a biological pathway may be arranged sequentially, corresponding to their arrangement (e.g., their sequential roles in a signaling cascade) in the biological pathway.

Another example of a method of indicating the perturbation of a pathway may include drawing a circular icon for each gene in a pathway, wherein the circular icon is color-coded (or otherwise differentially indicated) to show the sign and magnitude of the gene's differential regulation value. In some embodiments the color coded circle may be superimposed around (encircling) each gene's identifier. An additional example of a method of indicating the perturbation of a pathway may include drawing an open icon for genes whose p-levels are above a chosen threshold, and solid/closed icons for genes whose p-levels are below a chosen threshold or vise versa. In one embodiment, if multiple measurements of a gene have been made yielding multiple gene differential regulation values for a single gene, the multiple values may be visualized as described above, by arranging multiple icons (e.g., one per gene differential regulation value) proximate to one another and proximate to the gene's depiction in a pathway diagram. Other perturbation indicators for genes and biological pathways may be used as well as other methods of displaying/visualizing the perturbation of genes and/or biological pathways.

As mentioned herein, the aforementioned perturbation indicators/display methods may be used for some or all of the biological pathways for a single experimental condition. However, these indicators/display methods may also be used for some or all of the biological pathways for a number of different experimental conditions (e.g. different diseases, different drugs, different time points, or other conditions) simultaneously. Additionally, these different experimental conditions may be utilized in unique ways to group and/or analyze the experimental results. For example, beyond or in addition to parallel analysis of individual experimental conditions, one may rank the perturbation values of a pathway for a number of experimental conditions, then rank the experiments according to how greatly they perturb the pathway of interest. Additional examples of analysis may include: ranking the perturbation values of all the experiment-pathway instances to pick those combinations which create the greatest pathway perturbation; applying unsupervised clustering to the biological pathways, across experiments, to show pairs or groups of pathways which are similarly perturbed across experimental conditions; applying unsupervised clustering to the experimental conditions, across pathways, to show pairs or groups of experiments which similarly perturb the pathways; or other methods.

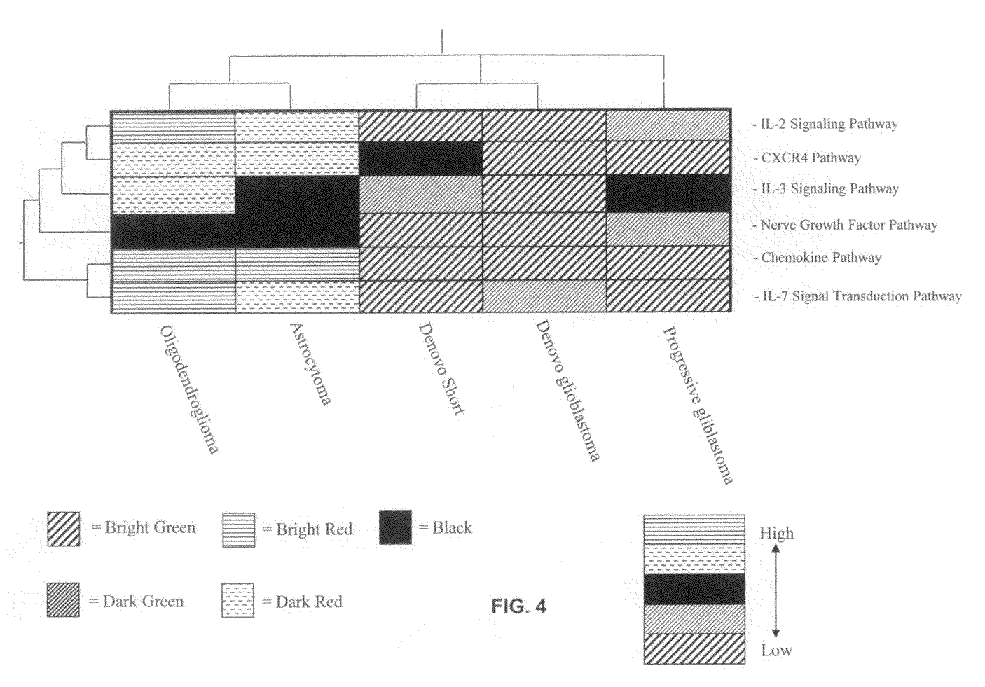

FIG. 4 illustrates a graph produced using an unsupervised clustering method (in this case a hierarchical clustering) that is performed on a perturbation matrix of pathway perturbation values, such as the matrix illustrated in FIG. 3. FIG. 4 illustrates clustering of the pathway perturbation matrix where each column is a different condition and each row is a different pathway. Each block within the matrix may be color coded (or otherwise differentially indicated) to indicate the degree of perturbation of the corresponding pathway in the corresponding condition. As can be seen from this figure, biological pathways are grouped together on the horizontal axis and experimental conditions may be grouped on the vertical axis (other configurations may be used).

In some embodiments, pathway perturbation values may be bounded to a range between a predefined minimum and maximum value. In other embodiments, pathway perturbation values may be open ended, not having any predefined limits to their value. In some embodiments, the bounded-ness or open-endedness of pathway perturbation values may be resultant from the specific algorithm, equation, or method used for their calculation. As such, clustering displays of pathway perturbation values may be color coded (or otherwise differentially indicated) according to the actual range of the pathway perturbation values.

In the example illustrated in FIG. 4, the biological pathways comprise a group where these pathways have low pathway perturbation values in three disease conditions: Denovo Glioblastoma, Denovo Short, and Progressive Glioblastoma. This can be observed by the fact that the pathway perturbation-condition element in the display for these pathways have a color indicator that has been designated to indicate low values (in the case of FIG. 4, the pattern indicative of bright green to dark green). On the other hand, in the remaining set of conditions, the same set of pathways are perturbed (in some cases very strongly) as indicated by a color indicator designated to indicate high values (in the case of FIG. 4, the pattern indicative of dark red to bright red, wherein black indicates a middle ground). Graphical indication of similarly regulated pathways may indicate a relation between these selected pathways that is shared among certain conditions (e.g., Denovo Glioblastoma, Denvo Short, and Progressive Glioblastoma) where these pathways are not perturbed. The example illustrated in FIG. 4 includes only the color indicators of bright red, dark red, black, dark green, and bright green. However, in some embodiments, various shades or blends of color falling in between those used to indicate high and low perturbation values (e.g., a gradual color scale from bright red, to black, to bright green) may be used. Additionally, other types of differential indicators (e.g., grey scale, differential patterns, or other differential indicators) may be used.

In addition to the use of clustering for visualization, the approach above can further be used to build a “classifier.” A classifier may include a system (e.g., a computer system) or part thereof (e.g., a software module) that is trained using a training set including various examples. Classifiers may be built using either supervised learning methods, unsupervised learning methods, or other learning methods.

In conjunction with pathway perturbation analysis, classifiers may be used to predict different types of diseases, treatment outcomes, or other attributes based on gene expression data. In the field of machine learning and pattern recognition, it is accepted that the number of samples needed to train a classifier should be at least on the order of the dimensionality of the input vector (e.g., the number of measurements made per sample that are used for training) in order to create a robust classifier. Sometimes, the number of training samples used is at least ten times the dimensionality of the input vector. In genomic applications, the expression levels of many thousands of genes or gene products may be measured per sample. However, the number of samples available for training a classifier may be much smaller such as, for example, on the order of a few hundreds. To reduce the dimensionality of the input space, and thus to improve the performance of a classifier, the conventional approach in the art for genomic data classifiers is to somehow filter or sub-select a set of genes from the large number of available measurements. These genes (or their protein products) are sometimes referred to as biomarkers for their specific application (e.g., colon cancer biomarkers). In this conventional approach, much valuable information present in the discarded gene measurements is lost.

In one embodiment of the invention, instead of using gene expression levels or gene differential regulation levels directly to create a classifier, pathway perturbation values may be used to create pathway perturbation patterns (by integrating the expression data with pathway information) and are then used as input into a classifier. This approach provides at least two distinct benefits. First, the number of pathways may be much smaller than the number of genes measured, thus, the dimensionality of the input space is reduced. While dimensionality may be reduced using other methods such as, for example, principle component analysis, the use of pathway perturbation values provides another advantage. It enables a more “intelligent” approach to dimensionality reduction by using a priori biological knowledge regarding genes and their function and interaction. Thus the invention enables the construction and use of superior classifiers.

In one embodiment, each training condition in the training set may have a pathway perturbation pattern comprising the level of perturbation of each pathway measured along with the class label of the condition. Using a supervised learning algorithm such as, for example, back-propagation learning, decision trees, support vector machines, or other algorithms, a classifier may be constructed. Subsequently, the classifier may be used to perform class prediction on new experimental conditions once their pathway perturbation patterns are obtained.

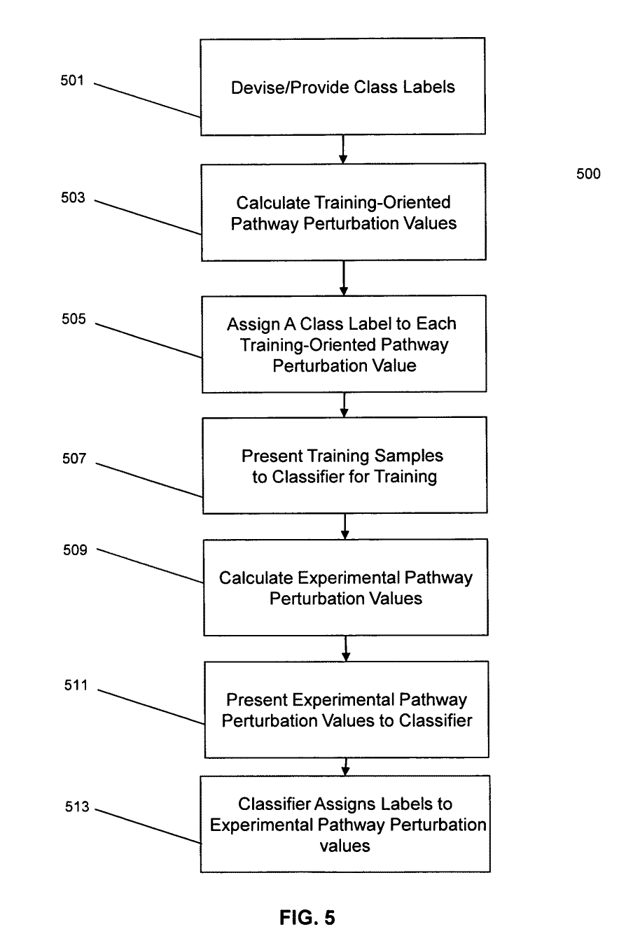

FIG. 5 illustrates process 500, wherein a classifier may be built using supervised learning methods. In an operation 501, a set of class labels may be devised or provided. For example, in one set of experiments, each sample from which gene expression data was measured belongs to one of three class labels: Normal, Non-Aggressive Cancer, and Aggressive Cancer. Other class labels may exist. In some embodiments, these class labels may be provided or predetermined such as, for example, where certain classes are known (e.g., supervised clustering of data). In other embodiments, these class labels may need to be devised such as, for example, when differentiating characteristics/classes of data are unknown. In these embodiments, unsupervised clustering may be used to devise class labels.

In an operation 503, a set of training-oriented pathway perturbation values for each pathway-condition data set may be calculated according to the methods set forth herein. This may be accomplished by generating pathway perturbation values for a “training data set.” In one embodiment, the training data set may include gene expression values for a plurality of genes for a plurality of experimental conditions and for control conditions. In one embodiment, the training data set may also include gene differential regulation values for each of the plurality of genes for the plurality of experimental conditions. In some embodiments p-values may also be included in the training data set.

In an operation 505, each training-oriented pathway perturbation value is then associated with a class label. In one embodiment, this may be done by first associating a class label to each experimental condition. For example, if the three class labels including Normal, Non-Aggressive Cancer, and Aggressive Cancer, and Conditions 1 through 5 exist in the experimental data, it may be determined that Condition 1 is “Normal,” Conditions 2 and 5 are “Non-Aggressive Cancer,” and Conditions 3 and 4 are “Aggressive Cancer.” As such, the pathway perturbation values in the training data set that result from those conditions will be assigned class labels accordingly. Other methods of associating training values to class labels may be used.

In an operation 507, the classifier is trained by presenting the training-oriented pathway perturbation values to the classifier along with the corresponding class label assigned to the training-oriented values. The goal of this training phase is to build a classifier that, once trained, can later be used to correctly identify class labels for new samples presented without any accompanying class labels. In one embodiment, training enables the classifier to develop a set of rules to classify pathway perturbation values that are presented to it in the future. Experimental data is then gathered into an experimental data set (e.g., gene expression values, gene differential regulation values, p-values and/or other data). Pathway information regarding the experimental data is introduced to the experimental data set and, in an operation 509, “experimental” (e.g., non-training-oriented) pathway perturbation values are calculated therefrom.

In an operation 511, these as-of-yet unclassified/experimental pathway perturbation values are then presented to the classifier, wherein the classifier, in an operation 513, associates a class label with each experimental pathway perturbation value according to the rules established in the training phase. This approach improves upon previous methods by, inter alia, integrating a priori information about biological pathways into a classification system and avoids using arbitrary filters to reduce the number of genes being fed into the classifier. The dimensionality of the input into the classifier is reduced to the size equal to the number of pathways used. If this is a large number, further dimensionality reduction can be performed using an unsupervised approach, such as self-organizing maps (discussed herein), principle component analysis, or other methods.

In addition to supervised training, unsupervised training methods may also be employed in cases where class labels are not provided during the training phase. In such cases, the unsupervised algorithm may perform clustering on the data and may attempt to identify groups of samples that have similar patterns. These groups may be used to devise class labels for the classifier. New samples may then be assigned to one of the existing clusters. For example, this type of approach may be used in cases where pathway perturbation measures have been made on conditions with unknown pathology. If, for example, an algorithm such as k-means is used, the experimental conditions may be divided into K different groups and each of these groups may be given its own different label.

In one embodiment, other unsupervised clustering methods may be used such as, for example, self-organizing maps (SOM) to organize, visualize, or classify pathway perturbation data. With these SOM algorithms, the data may be clustered together in such a way that cluster relationships maintain their proximate relationship in a higher dimensional space. For example, an experiment with 3 experimental conditions (all compared to a common control condition) and 5 analyzed biological pathways yields 15 pathway perturbation values (ρ_{pc}) using the operations and methods outlined above. Note that this example uses a rather small size matrix for the sake of simplicity. In some applications of the invention, the number of pathways may be large, sometimes on the order of thousands or more. In the above example, a matrix similar to that matrix 300 illustrated in FIG. 3 may result, wherein 5 rows exist, each corresponding to a different biological pathway, and 3 columns exist, each corresponding to a different experimental condition (in other embodiments, the pathways may be represented by columns and the experimental conditions may be represented by the rows). Each row of matrix 300 may be viewed as a perturbation profile of the corresponding biological pathway across the various experimental conditions. For example, Pathway 3 of FIG. 3, may be represented as a three dimensional vector [5.4, 4.2, 3.3]. Additionally, each column of matrix 300 maybe viewed as a perturbation profile or an experimental condition which perturbs the various pathways. For example, Condition 1 of FIG. 3 may be labeled a pathway perturbation profile and represented as a five dimensional vector [12.5, 7.3, 5.4, 3.1, 8.2].

In one embodiment, the pathway perturbation analysis data may be used to construct a elf-organizing map (SOM). At a basic level, a SOM algorithm may take as input a number of n-dimensional vectors, and assign each of these vectors to a “node” of a self-organizing map. In one embodiment, each node may have a corresponding “Codebook vector,” with the self-organizing map's dimensionality being equal to that of the input vectors presented to the SOM algorithm. The nodes of the self-organizing map are organized in a predefined topological organization, wherein each node is connected to a subset of the other nodes in the self-organizing map (its local “neighborhood”). The objective of the SOM algorithm is to assign input vectors to nodes on the self-organizing map such that “similar” vectors are placed in the same node or one of its close neighbors. The assignment is done by comparing the input vector to all the Codebook vectors (one per each node of the map). The input vector is then assigned to the node that has the most similar codebook vector. In some embodiments, the SOM algorithm will then adjust the codebook vector of the selected node and its topological neighbors to become more similar to the presented input vector. Therefore, the input space is mapped into the self-organizing map space such that the vectors that are similar in the input space (e.g., they share or have close values for their respective dimensions) are physically placed close together in the self-organizing map space.

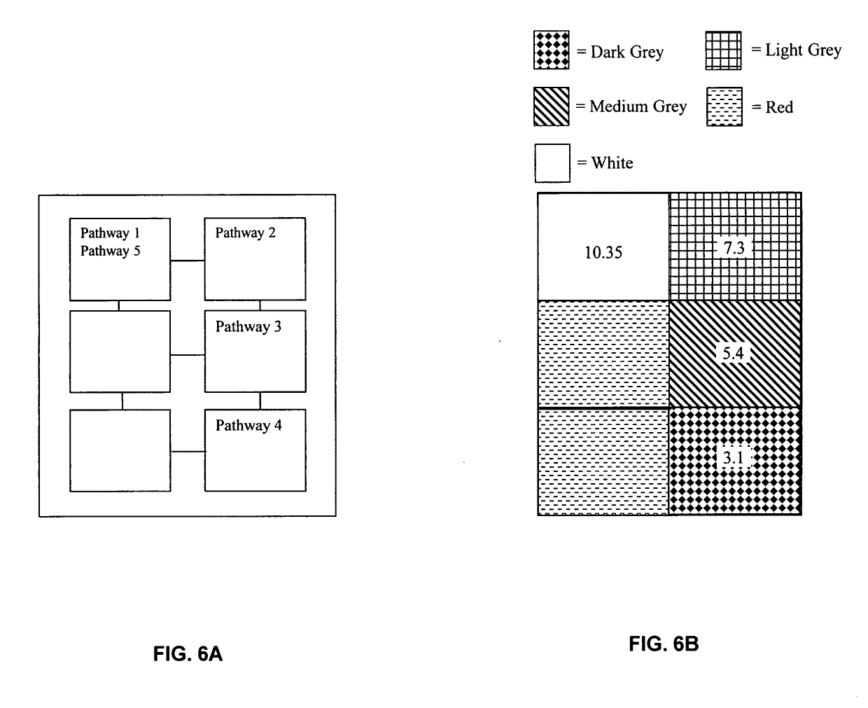

In the previous example, using values from matrix 300 of FIG. 3, a two-dimensional self-organizing map may be used for illustration. If the rows of the pathway perturbation matrix 300, of FIG. 3 are used as input vectors of dimensionality three, the SOM algorithm may map this three-dimensional space into a two-dimensional space where pathways are assigned to nodes of a two dimensional map. FIG. 6A illustrates an example of this two-dimensional map space, wherein the pathways of FIG. 3 are mapped into each node. Alternatively, the experimental conditions may be used as five-dimensional input vectors and map them into the two-dimensional self-organizing map. In this case, each experimental condition would be mapped to a particular SOM node.

Using the data from the example illustrated in FIG. 3, it may be concluded that Pathway 1 is most similar to Pathway 5 with respect to its perturbation pattern across the three experimental conditions. Furthermore, Pathway 2 is similar in profile to Pathways 1 and 5 as well as Pathway 3. However, Pathway 3 is less similar to Pathways 1 and 5 than to Pathway 2. The pathways are arranged in the map of FIG. 6A accordingly. Although the example of a self-organizing map of FIG. 6A illustrates a two dimensional map space, self-organizing maps having map spaces of greater dimensions may be utilized according to the invention.

In one embodiment, once the self-organizing map has been created, it may be used in one or more ways as a visualization tool. If the self-organizing map is two or three-dimensional, each node of the self-organizing map may be color coded (or otherwise differentially indicated) using a color map based on a property or characteristic of the SOM node. For example, if the self-organizing map was created using perturbation levels of each biological pathway as input, as illustrated in FIG. 6A, each node of the self-organizing map may be color-coded (or otherwise differentially indicated) to indicate the average pathway perturbation level of the pathways in that node for a particular condition, as illustrated in FIG. 6B. Using the example data used to create the self-organizing map illustrated in FIG. 6A, this could lead to three separate color-coded (or otherwise differentially indicated) maps (one of which is illustrated in FIG. 6B), each corresponding to a different condition (there being three experimental conditions in the data from FIG. 3 used to create FIG. 6A).

FIG. 6B illustrates a self-organizing map display wherein the average pathway perturbation values corresponding to Condition 1 of the example data illustrated in FIG. 3 are assigned to the nodes of the self-organizing map of FIG. 6A. In the illustration of FIG. 6B, zero is mapped to the color black, and 10.35 is mapped to the color white. 10.35 is mapped to the color white because it is the highest perturbation value in the nodes of the self-organizing map of FIG. 6B (10.35 being the average of Pathway 1 and Pathway 5 perturbation values). In some embodiments, shades of grey may be used to represent the range of numbers between 10.35 and zero. For SOM nodes that do not have any pathways mapped to them (e.g., col. 1, row 2 and col. 1, row 3 of FIG. 6A), a different color such as, for example, red, may be used. In some embodiments, other colors or other methods of differential indication may be used.

In some embodiments, representations of self-organizing maps may utilize other representations of SOM nodes. For example, instead of using average pathway perturbation values for a given condition (such as in the example illustrated in FIGS. 6A and 6B), a Codebook vector element value corresponding to Condition 1 may be used as the basis for coloring each node. Using this measure may create a more smooth representation of the self-organizing map. Because the Codebook vectors are updated based on both the input data they receive and the location of the Codebook vectors in neighboring SOM nodes, the updating algorithm may implicitly provide a smoothing mechanism so that the change in Codebook values is gradual from one SOM node to the next neighboring SOM node.

The color-coded (or otherwise differentially indicated) representations discussed above may be helpful in visualizing global pathway perturbation patterns. For example, if Conditions 1 through 3 were sequential time points gathered at consecutive time points of a cell development process, observing the resulting three self-organizing map plots (one per condition) in the corresponding sequence may aid a user to visualize the dynamics of pathway perturbation as the cell goes through various developmental stages.

FIGS. 6A and 6B and many of the examples discussed above have concentrated on self-organizing maps where pathways are mapped to SOM nodes. Similar results, albeit with different perspectives, may be obtained when experimental conditions are mapped SOM nodes. When experimental conditions are mapped to SOM nodes, conditions that have similar pathway perturbation patterns are mapped to local neighborhoods in the self-organizing map.

In some embodiments, the above discussed analysis and/or other analysis maybe pursued further. For example, the self-organizing map thus created may be used as the basis for constructing a classifier system. The self-organizing map may provide a dimensionality reduction step, where M pathway perturbation values for each condition are mapped to N Codebook values. In an example using the data illustrated in FIGS. 3 and 6A, the number of pathways, M=5 and the number of codebook vectors, N=6. As such, the pathway perturbation profile for a given condition will be mapped from five dimensions to six dimensions. In this example, the dimensionality has increased from 5 to 6. However, as stated earlier, in practical applications, the number of pathways will typically be much larger than the five used in this example, such as on the order of thousands. Thus the self-organizing map may typically reduce the dimensionality of a large amount of data down to a smaller number, depending on the number of nodes used in the self-organizing map. In one embodiment, using the output of the self-organizing map in building a classifier may yield much better performance in terms of robustness and accuracy.

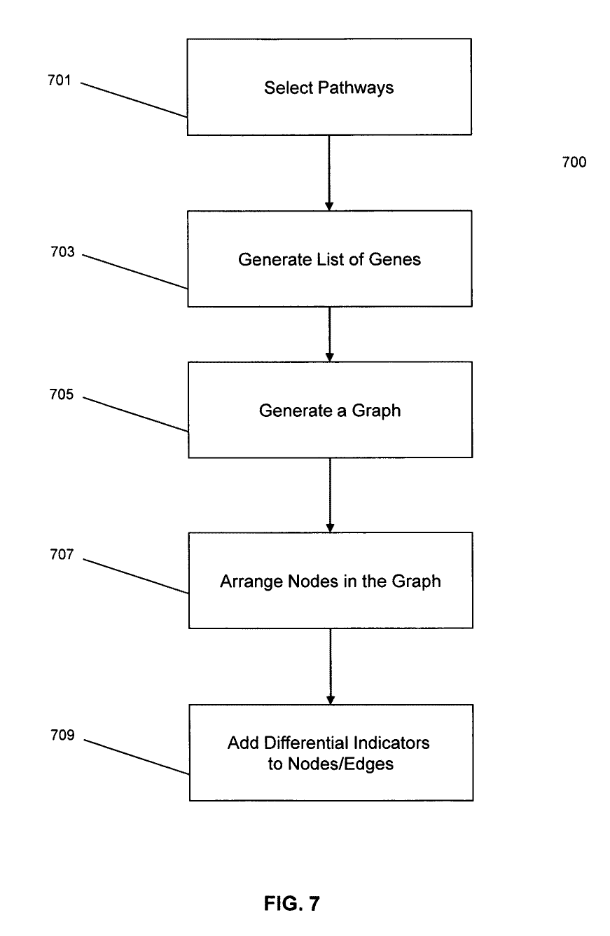

In some embodiments, this and other analysis may be pursued further. In one embodiment, a new “meta-pathway” or network of genes may be computationally constructed and visualized. This visualization may take the form of a graph or diagram which may be constructed using any number of methods. FIG. 7 illustrates a process 700, an example wherein a graph or diagram of a meta-pathway may be created. In an operation 701, a subset of biological pathways may be selected based on their pathway perturbation values across one or more experimental conditions or based on other criteria. For example, the subset of biological pathways may be selected because the pathways in the subset are all similarly perturbed by one or more experimental conditions. In some embodiments, all genes of all relevant biological pathways for which data is available may be included in the list.

In an operation 703, a list of genes residing in the subset of selected pathways may be created. In one embodiment, the list of genes may include only those genes that are that are present in all of the selected pathways of the selected subset of biological pathways (a union of set of genes in the pathways). In some embodiments, the list of genes may include genes that are simply present in more than one of the subset of selected biological pathways (e.g., any genes that are shared by at least two pathways. In one embodiment, this list may include all genes present in all of the selected pathways. In one embodiment, the genes present in the list may be filtered by a predetermined p-value threshold. In this embodiment, the p-values associated with gene differential regulation values for relevant experimental conditions may be used as a filter.

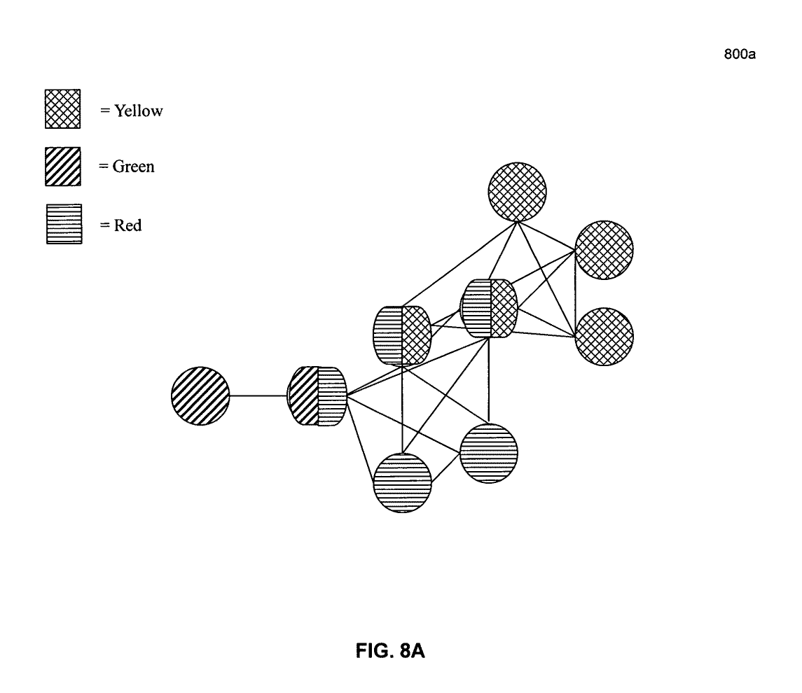

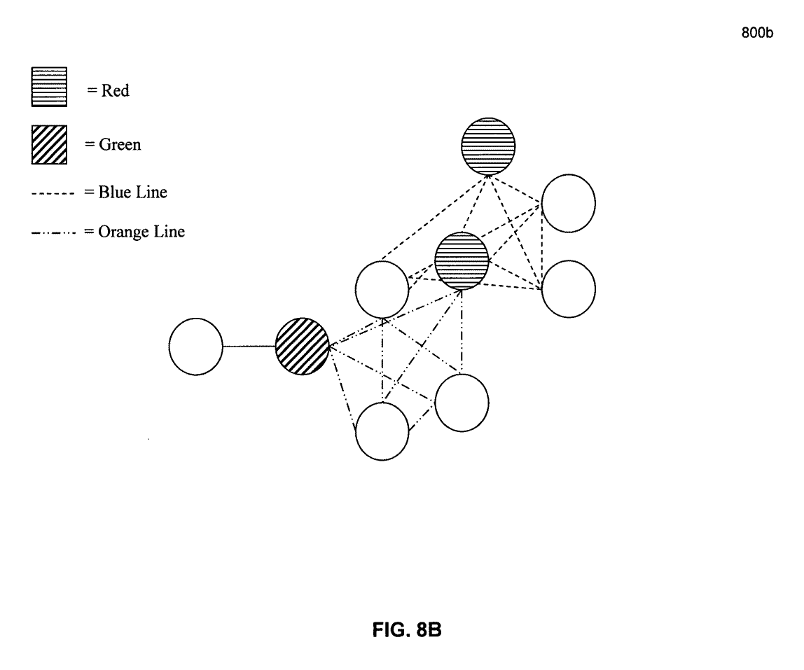

In an operation 705, a graph may be created where each node of the graph represents one of the genes in the list (e.g., the meta-pathway) and links between the genes which represent genes that are present in the same pathway are represented by edges between the nodes. FIG. 8A illustrates a graph according to an embodiment of the invention wherein genes are shown as nodes. In one embodiment, the edges of a graph created to illustrate a meta-pathway may be weighted according to a set of criteria such as, for example, if the two genes are not listed together as being present in the same pathway, the weight is zero and no edge is drawn between these nodes of the graph, otherwise, the weight of the edge is equal to the number of pathways where this pair of genes are both listed as members.

In some embodiments, edges may also be created between the genes, where one gene belongs to one pathway and another gene belongs to another pathway. In these embodiments, the weight for this edge may be set as a function of the similarity between the perturbation profiles of each pathway having the genes. For example, if Gene A belongs to Pathway 1 and Gene B belongs to Pathway 5, an edge may be placed connecting the nodes representing Gene A and Gene B with the edge weight set to a function ƒ comparing the perturbation of Pathway 1 to Pathway 5 across some or all experimental conditions. The similarity function ƒ may be selected such that very similar (or identical) perturbation profiles will yield the largest weight, and the most dissimilar perturbation profiles generate a value close to zero (essentially, no connection). It may also be noted that an anti-correlation pattern should typically not be considered “dissimilar,” as the anti-correlation likely indicates some type of inverse regulation. As such, an example of function ƒ may include the absolute value of a Pearson Correlation function comparing the two pathways.

In an operation 707, the nodes in the graph illustrating a meta-pathway may arranged in such a way that the nodes representing genes with the largest value weights between them are drawn proximally relative to lesser weighted gene pairs. An optimization tool may be used to identify the best layout of nodes onto a two-dimensional plane for the generated meta-pathways.

In an operation 709, some or all nodes and/or edges in the graph may have differential indicators applied to them to indicate certain qualities of their representative genes or potential gene relationships. In some embodiments, differential indicators may include differential coloration, shading, textured/dashed fill or lines, or other differential indicator or combination thereof. For example, in some embodiments, a node within a graph may be visualized as a color-coded pie chart, the sections in the pie chart representing the different pathways in which the gene represented by the node resides. For this operation, each node representing a gene belonging to more than one pathway may be segmented according to the number of pathways to which it belongs. Each pathway represented in the graph may then be assigned a different color. Finally, each segment of each node may be colored according to the pathway it represents. FIG. 8A illustrates a graph 800a according to an embodiment of the invention wherein nodes are segmented and differentially colored.

The graphs representing meta-pathways that are constructed in the fashion described above may be drawn as new “computationally derived” pathway diagrams. The same visualization tools that were described above for overlaying expression information on pathway diagrams, sorting, and selecting various pathways may now be performed on these derived pathways. In other embodiments, graphs illustrating meta-pathways may be constructed wherein links between nodes in the network (e.g., edges) are differentially indicated according to their respective biological pathway. In these embodiments, differential indication of nodes may be used to denote the level of expression of the gene represented by the node.

FIG. 8B illustrates a graph 800b according to an embodiment of the invention, wherein nodes without fill represent genes that do not have any measured expression values and nodes with fill indicate the up-regulated or down-regulated gene differential expression value of the gene represented by that node. In one embodiment, multiple segments may also be used within the nodes of graphs similar to graph 800b to denote multiple measurements of the same gene. The color, shading, texture, or other differential indicator of the links in graph 800b, or similar graphs, may denote the particular pathway in which the pair of genes are members.

In some embodiments, process 700 and similar processed according to the invention, including those producing graphs the same as or similar to graphs 800a and 800b, may be used to explore previously unknown associations between genes within and among biological pathways. Other uses may also exist.

Those having skill in the art will appreciate that the processes or methods of the invention described herein may work with various configurations. Accordingly, more or less of the operations of the aforementioned processes or methods may be performed and may be used and/or combined in various sequences or embodiments.

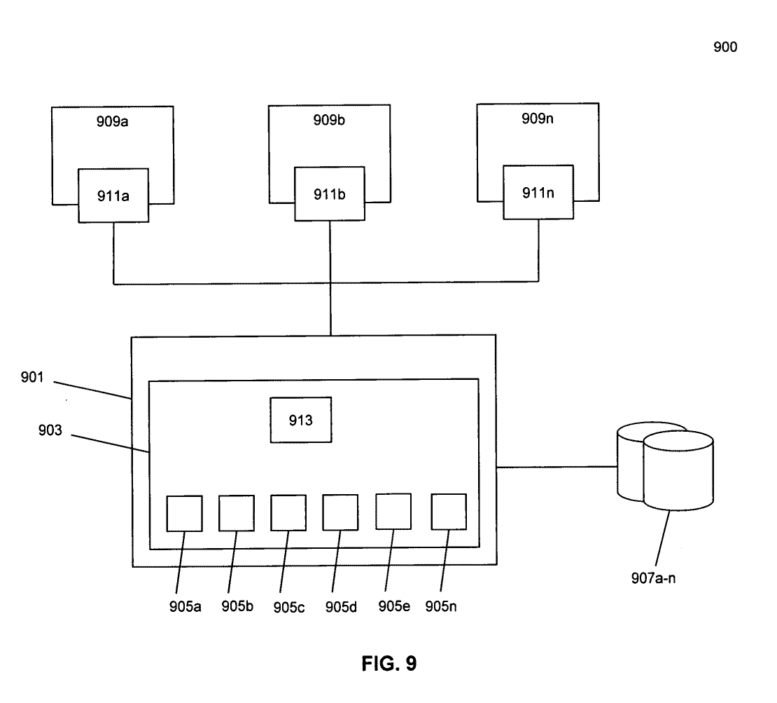

According to an embodiment of the invention illustrated in FIG. 9, the invention provides a system 900 that enables performance of pathway perturbation analysis and/or other features described herein. Computer implemented system 900 may include a computer system 901, a control application 903, one or more software modules 905a-n, one or more data storage devices 907a-n, one or more terminal devices 909a-n, one or more graphical user interfaces 911a-n, and/or other elements.

Computer system 901 may include one or more personal computers, laptop computers, servers, or other machines which may be or include, for instance, a workstation running the operating system sold under the trademark Microsoft® Windows® NT, the operating system sold under the trademark Microsoft® Windows2000, the operating system sold under the trademark Unix®, Linux, Xenix, IBM, the operating system sold under the trademark AIX®, the operating system sold under the trademark Hewlett-Packard UX™, the operating system sold under the trademark Novell® Netware®, the operating system sold under the trademark Sun Microsystems Solaris™, the operating system sold under the trademark OS/2™, the operating system sold under the trademark BeOS™, Mach, Apache, the programming interface sold under the trademark OpenStep™, or other operating systems or platforms. Computer system 901 may include one or more processors 913 which may receive, send, and/or manipulate data for the performance of the features, functions, and or operations of the invention as described herein, including the any or all of the operations of the methods illustrated in the figures herein and/or other methods.

According to one embodiment, computer system 901 may host a control application 903. Control application 903 may comprise a website or computer application. According to an embodiment of the invention, control application 903 may include or comprise one or more software modules 905a-n for receiving gene expression values; calculating gene differential regulation values; calculating pathway perturbation values; calculating p-values; performing various statistical calculations; grouping or clustering genes, gene expression values, or gene differential regulation values according to supervised or unsupervised clustering; grouping or clustering biological pathways or pathway perturbation values according to supervised or unsupervised clustering; formulating and/or displaying perturbation indicators for genes or biological pathways; formulating and/or displaying matrices or charts regarding gene or biological pathway perturbation; formulating and/or displaying meta-pathways and/or graphs or charts of meta-pathways; utilizing self-organizing algorithms to construct self-organizing maps; formulating training values for a classifier; formulating class labels for a classifier; applying class labels to training values; presenting training values and class labels to a classifier; devising classification rules; applying classification rules to experimental values; assigning class labels to experimental rules and/or for performing other operations or functions, including those described herein.

In particular, control application 903 may include a receiving module 905a. In one embodiment, receiving module 905a may enable the calculation or receipt of gene expression values. In some embodiments receiving module 905a may enable the calculation or receipt of other data or may perform other functions, including those described herein.

Control application 903 may also include a calculation module 905b. In one embodiment, calculation module 905b may enable operations or statistical methods for calculating gene differential expression values, pathway perturbation values, and/or p-values. In some embodiments, calculation module 905b may enable the calculation of other values or may perform other functions, including those described herein.

Control application 903 may also include a clustering module 905c. In one embodiment, clustering module 905c may enable the grouping or clustering of genes, gene expression values, gene differential regulation values, biological pathways, experimental conditions, and/or pathway perturbation values using supervised and/or unsupervised clustering techniques. In some embodiments, clustering module 905c may enable the formulation and/or display of matrices, charts, graphs, self-organizing maps, and/or the performance of other functions, including those described herein.

Control application 903 may also include a graphing module 905d. In one embodiment, graphing module 905d may enable the formulation and display of graphs representing one or more meta-pathways or for enabling other functions, including those described herein.

Control application 903 may also include a classifier module 905e. In one embodiment, classifier module 905e may enable the formulation of class labels based on supervised clustering, unsupervised clustering, a priori knowledge, or other information. In one embodiment, classifier module 905e may also enable the application of class labels to training values, the receipt of training values and their associated class labels or other training data, the formulation of rules based on training data, the receipt of experimental data, the application of rules to experimental data, the classification of experimental data, or other functions, including those described herein.

Control application 903 may also include a presentation module 905f. In one embodiment, presentation module 905f may enable the presentation of data, including training-oriented and/or experimental pathway perturbation values, or other data to classifier module. Other features of the invention, including features described above may be enabled by other modules included in control application 903. One or more of the modules included in control application 903 may be combined. For some purposes, not all modules may be necessary.

In some embodiments, computer system 901 may be operatively connected to one or more data storage devices 907a-n. Data storage devices 907a-n may be utilized to store any of the data utilized by or produced by any of the processes or functions described herein. Data storage devices 907a-n may be, include, or interface to, for example, a relational database sold commercially under the trademark Oracle® by Oracle Corporation. The database sold under the trademark Informix®, DB2 (Database 2) or other data storage or query formats, platforms, or resources such as OLAP (On Line Analytical Processing), SQL (Standard Language Query), a SAN (storage area network), the relational database management system sold under the trademark Microsoft® Access®, or others may also be used, incorporated, or accessed into the invention.

In one embodiment, computer system 901 may be operatively connected to one or more terminal devices 909a-n. This operative connection may occur over a network (e.g., the Internet) or other operative connection. Communication between computer system 901 and one or more terminal devices 909a-n may be utilized to transmit, display, and/or visualize data in the form of lists, matrices, charts, graphs, groups, diagrams, self-organizing maps or other format via one or more graphical user interfaces 911a-n.

One or more terminal devices 909a-n may include a personal computer, a server, a dumb terminal, a laptop computer, a personal digital assistant (PDA), or other device. In some embodiment, one or more terminal devices 909a-n may include a wireless terminal device.

Those having skill in the art will appreciate that the invention described herein may work with various system configurations. Accordingly, more or less of the aforementioned system components may be used and/or combined in various embodiments. It should also be understood that various software modules 905a-n and control application 903 that are utilized to accomplish the functionalities described herein may be maintained on one or more of computer system 901, processors 913, terminal devices 909a-n or other components of system 900, as necessary. In other embodiments, as would be appreciated, the functionalities described herein may be implemented in various combinations of hardware and/or firmware, in addition to, or instead of, software.

In one embodiment, the invention may include a computer readable medium containing instructions that, when executed by at least one processor (such as, for example processor 913 of system 900), cause the at least one processor to enable and/or perform the features, functions, and or operations of the invention as described herein, including the any or all of the operations of the processes described in specification or the figures, and/or other operations.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

We claim:

1. A computer-implemented method for analyzing the perturbation of one or more biological pathways, comprising:
receiving expression values for each of a plurality of genes for one or more experimental conditions, wherein one or more of the plurality of genes reside in one of one or more biological pathways;
calculating a gene differential regulation value for each of the plurality of genes for each of the one or more experimental conditions, wherein the gene differential regulation value is obtained by comparing the expression values to a control expression value for each of the plurality of genes;
grouping the gene differential regulation values by the biological pathway and experimental condition from which each gene differential regulation value originated yielding one or more pathway-condition data sets; and
calculating a pathway perturbation value for each of the one or more pathway-condition data sets using one or more of the gene differential regulation values in a particular pathway-condition data set to calculate the pathway perturbation value.

2. The method of claim 1, wherein calculating a pathway perturbation value further comprises calculating a pathway perturbation value using a multivariate chi-squared statistic.

3. The method of claim 1, wherein calculating a pathway perturbation value further comprises, for each of the pathway-condition data sets:
calculating a p-value for each of the one or more gene differential regulation values in the pathway-condition data set, and
selecting a subset of the one or more gene differential regulation values from which to calculate the pathway perturbation value, wherein the subset is selected based on the p-value for each gene differential regulation value.

4. The method of claim 1, wherein calculating a pathway perturbation value further comprises, for each of the pathway-condition data sets:
calculating a p-value for each of the one or more gene differential regulation values in the pathway-condition data set, and
weighting the gene differential regulation values according to their p-value.

5. The method of claim 1, further comprising clustering the one or more biological pathways based on their pathway perturbation values across one or more of the one or more experimental conditions.

6. The method of claim 5, wherein clustering the one or more biological pathways includes utilizing a self-organizing map algorithm.

7. The method of claim 1, further comprising clustering the one or more experimental conditions based on their pathway perturbation values across one or more of the one or more biological pathways.

8. The method of claim 7, wherein clustering the one or more experimental conditions includes utilizing a self-organizing map algorithm.

9. The method of claim 1, further comprising displaying the pathway perturbation values in a matrix format, wherein a first axis includes a biological pathway to which each pathway perturbation value belongs, and wherein a second axis includes an experimental condition to which each pathway perturbation value belongs.

10. The method of claim 9, wherein a graphical indicator of a magnitude of pathway perturbation is superimposed on each pathway of the matrix.

11. The method of claim 10, wherein the graphical indicator is a color-coded indicator.

12. The method of claim 1, further comprising:
selecting a subset of the one or more biological pathways;
generating a list of genes that are present in all of the selected pathways; and
generating a graph having a plurality of nodes joined by edges, wherein each node in the graph represents one of the genes in the list, and wherein two nodes are joined by an edge.

13. The method of claim 12, wherein generating a graph further comprises joining two nodes of the graph with an edge when the genes represented by the two nodes are present in a common pathway.

14. The method of claim 12, wherein selecting a subset of the one or more biological pathways further comprises selecting subset of the one or more biological pathways based on their pathway perturbation values across two or more experimental conditions.

15. The method of claim 12, further comprising calculating a weight for each stage wherein the nodes in the graph are arranged according to the weights of each edge in the graph, wherein the larger value weight for an edge between two nodes cause the two nodes to be drawn proximally.

16. The method of claim 15, wherein calculating the weight for each edge is performed according to a number of common biological pathways with any give pair of genes, wherein the weight increases with the number of common biological pathways.

17. The method of claim 15, wherein calculating the weight for each edge is performed according to a function of similarity between pathway perturbation values of each pathway in which the genes reside, wherein the weight increases with as the similarity between the pathway perturbation values increases

18. The method of claim 12 wherein each node in the graph is segmented according to the number of biological pathways of which it is a part, wherein each biological pathway is assigned a different differential indicator, and wherein each segment is differentially indicated according to its representative pathway.

19. The method of claim 12, wherein each pathway is assigned a different differential indicator, and wherein each edge is differentially indicated according to its representative pathway.

20. The method of claim 19, wherein each gene is assigned to a differential indicator, and wherein each node is differentially indicated according to its representative gene regulation value.

21. A computer-implemented system for classifying pathway perturbation values, wherein a pathway perturbation value is a measure of the magnitude of perturbation of gene expression levels in a biological pathway under an experimental condition, the method comprising:
generating a set of two or more training-oriented pathway perturbation values from a training data set;
devising a set of class labels to be applied to the training-oriented pathway perturbation values,
applying at least one class label of the set of class labels to each of the training-oriented pathway perturbation values; and
presenting the training-oriented pathway perturbation values and associated class labels to a classifier module, wherein the classifier module establishes a set of rules based on the pathway perturbation values to produce the class labels associated with them.

22. The method of claim 21, further comprising:
generating at least one experimental pathway perturbation value from an experimental data set;
presenting the at least one experimental pathway perturbation value to the classifier module; and
applying at least one of the set of class labels to the at least one experimental pathway perturbation value based on the set of rules.

23. The method of claim 21 wherein generating a set of two or more training-oriented pathway perturbation values further comprises reducing the dimensionality of the set of two or more training-oriented pathway perturbation values.

24. The method of claim 23, wherein reducing the dimensionality of the set of two or more training-oriented pathway perturbation values includes utilizing a self-organizing map algorithm.

25. The method of claim 23, wherein reducing the dimensionality of the set of two or more training-oriented pathway perturbation values includes utilizing a principle component analysis algorithm.

26. A computer-implemented system for analyzing the perturbation of one or more biological pathways, comprising:
a receiving module adapted to receive expression values for each of a plurality of genes for one or more experimental conditions, wherein one or more of the plurality of genes reside in one of one or more biological pathways;
a calculation module adapted to calculate a gene differential regulation value for each of the plurality of genes for each of the one or more experimental conditions, wherein the gene differential regulation value is obtained by comparing the expression values to a control expression value for each of the plurality of genes; and
a clustering module adapted to cluster the gene differential regulation values by the biological pathway and experimental condition from which each gene differential regulation value originated yielding one or more pathway-condition data sets,
wherein the calculation module is also adapted to calculate a pathway perturbation value for each of the one or more pathway-condition data sets using one or more of the gene differential regulation values in a particular pathway-condition data set to calculate the pathway perturbation value.

27. A computer-implemented system for classifying pathway perturbation values, wherein a pathway perturbation value is a measure of the magnitude of perturbation of gene expression levels in a biological pathway under an experimental condition, comprising:
generating a set of two or more training-oriented pathway perturbation values from a training data set;
devise a set of class labels to be applied to the training-oriented pathway perturbation values, and
apply at least one class label of the set of class labels is applied to each of the training-oriented pathway perturbation values; and
a presentation module adapted to present the training-oriented pathway perturbation values and associated class labels to a classifier module to establish a set of rules based on the pathway perturbation values and the class labels associated with them.
